(19) United States
(12) Patent Application Publication
(10) Pub. No.: US 2009/0071680 A1
(43) Pub. Date: Mar. 19, 2009

(54) ELECTRICAL GANG BOX FOR CONTROLLING AN ELECTRICAL SYSTEM

(76) Inventors: Rhonda Lee Ailer, Churchville, VA (US); Arnold Everett Ailer, JR., Churchville, VA (US); Matthew Ryan Ailer, Churchville, VA (US); Christopher Ray Lee Ailer, Churchville, VA (US)

Correspondence Address: DITTHAVONG MORI & STEINER, P.C., 918 Prince St., Alexandria, VA, 22314, US

(21) Appl. No.: 11/855,842

(22) Filed: Sep. 14, 2007

(51) Int. Cl. H01R 13/50

(52) U.S. Cl. 174/57; 174/53; 174/58; 174/64; 340/660

(57) ABSTRACT

A receptacle-receiver unit is provided for an electrical system, such as a lighting system. The unit includes a receptacle having a plurality of female slots and a plurality of male ends, wherein the female slots are configured to receive a plug of the lighting system. The unit also includes a receiver wired to a power supply and the receiver has plurality of female slots configured to receive male ends of the receptacle. The female slots of the receiver and the male ends of the receptacle are engaged without wiring process to deliver electric flow to the lighting system.

### FIELD OF THE INVENTION

The present invention, according to certain embodiments, relates generally to power and control systems, and particularly to electrical modules.

### BACKGROUND INFORMATION

It is well recognized that interior design continues to evolve through the manipulation of spatial volume and functional layout. Generally, architects draw on aspects of psychology, ergonomics, and style to shape the experience of a given space before owner occupancy. In this regard, interior environments typically comprise a matrix of rooms bounded by fixed walls and doors. Moreover, the overall look and feel of individual spaces is supplemented by strategically placed electrical components, such as gang boxes, receptacles, switches, and lighting fixtures, as well as other functional accessories. As such, these components are conventionally provided in relatively “set” locations and are characterized by relatively “established” control relationships. That is, an electrical design will typically include gang boxes (including electrical receptacles and/or switches for controlling light fixtures) in predetermined locations, such that one or more particular switches, control one or more particular lights. If, however, an occupant's intended use, need, or whimsical desire changes, expensive reconstruction and electrical rewiring must be incurred to convert the space.

Further, as most interior electrical designs permit little reconfiguration after initial construction, modifications frequently require skilled tradespersons who create a disruption in the space while undertaking the remodeling procedures. Such alterations also create additional expense and waste. Accordingly, it is not uncommon for occupants to evaluate their infrastructure and determine how to “fit” their needs into their existing environment. As such, it would be advantageous, more efficient, and less costly if occupants could, instead, “drive” the functional layout of an environment at any given point in time.

Therefore, a need exists for systems, methods, and devices that enable users to seamlessly reconfigure an interior environment without incurring expensive reconstruction and/or electrical rewiring costs. There exists a particular need for such systems, devices and methodology that enable users to safely modify electrical designs without requiring physical rewiring, additional electrical components, or substantial assembly or disassembly of parts. There is still a further need for electrical modules that permit alternation of control relationships on the fly.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of an environment providing electrical gang boxes for controlling and configuring electrical devices, according to an exemplary embodiment;

FIGS. 2A and 2B are a front view and cross-sectional view of an electrical gang box, according to an exemplary embodiment;

FIGS. 3A and 3B are a front view and a cross-sectional view of a housing of the electrical gang box of FIG. 2, according to an exemplary embodiment;

FIGS. 4A-4C are a front, a cross-sectional, and a back view of a receiving module of the electrical gang box of FIG. 2, according to an exemplary embodiment;

FIGS. 5A-5C are a front, a cross-sectional, and a rear view of a receptacle module of the electrical gang box of FIG. 2, according to an exemplary embodiment;

FIGS. 6A and 6B are flowcharts of processes for installing and reconfiguring an electrical gang box, according to various exemplary embodiments;

FIGS. 7 and 8 are diagrams of control devices configured to permit users to manage the configurable state of an electrical gang box, according to exemplary embodiments; and

FIG. 9 is a flowchart of a process for controlling an electrical device via control device, according to an exemplary embodiment.

### DESCRIPTION OF THE PREFERRED EMBODIMENTS

A system, method, and apparatus for providing adjustable electrical gang boxes for controlling and configuring electrical devices are described. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the various exemplary embodiments are described with respect to interior environments, it is contemplated that these embodiments have applicability to exterior environments as well. Further, while the various exemplary embodiments are described as controlling light devices, it is contemplated that these embodiments may control other electrical components such as: audio-visual components (e.g., stereo systems, televisions, projector systems, etc.), computing devices (e.g., personal computers, printers, routers, etc.), kitchen appliances (refrigerators, microwaves, coffee machines, etc.), and office equipment (e.g., telephones, copy machines, fax machines, etc.), as well as other equivalent technologies.

Currently, alternative current electrical systems are problematic with respect to costs, safety, and functionality. As such, exemplary embodiments of the present invention enable seamless control and reconfiguration of electrical gang boxes without incurring expensive reconstruction and electrical rewiring costs. Various embodiments enable users to safely modify electrical designs without requiring physical rewiring processes, additional electrical components, or substantial assembly or disassembly of parts. Moreover, various embodiments of the invention enable “on the fly” implementation by lay individuals.

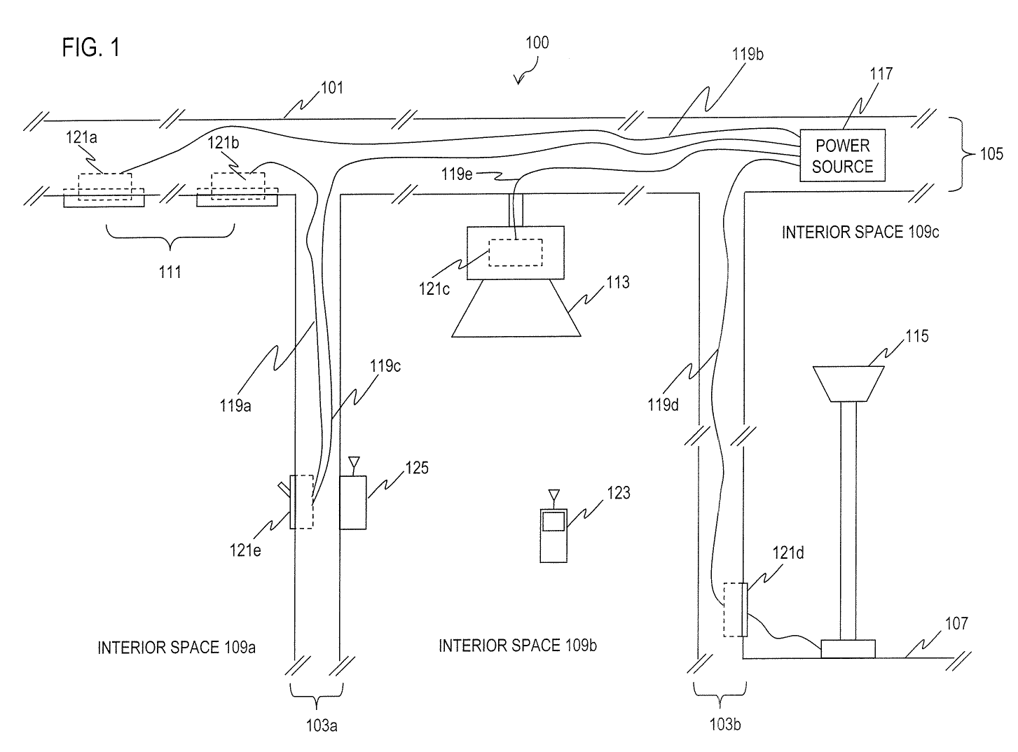

FIG. 1 is a diagram of an environment providing electrical gang boxes for controlling and configuring electrical devices, according to an exemplary embodiment. As shown, environment 100 comprises a building structure 101 including walls 103a and 103b, ceiling 105, and floor 107 defining various interior spaces, such as interior spaces 109a-109c. Building structure 101 may be implemented as a commercial environment (e.g., office, retail establishment, restaurant, industrial complex, etc.), a residential space (e.g., apartment, condominium, household, shed, outhouse, etc.), or other facility (e.g., hospital, school, library, church, government establishment, etc.), as well as define a temporary structural environment (e.g., convention center, trade show pavilion, exhibit, etc.) or some other living or working environment, such as a boat hull or airplane cabin.

According to the depicted embodiment, spaces 109a-109c include various electrical devices, such as recessed lighting network 111, overhead lighting system 113, and/or lamp 115. In the depicted embodiment, recessed lighting network 111 is installed within ceiling 105, overhead lighting system 113 is installed hanging from ceiling 105, and lamp 115 is free-standing. These devices are energized by power source 117 via wires 119a-119e and electrical gang boxes 121a-121e. Gang boxes 121a-121d are implemented as electrical receptacles, while gang box 121e is configured as a switch. In certain embodiments, gang boxes (e.g., box 121c) may be incorporated support structures of lighting systems, such as seen with respect to lighting system 113.

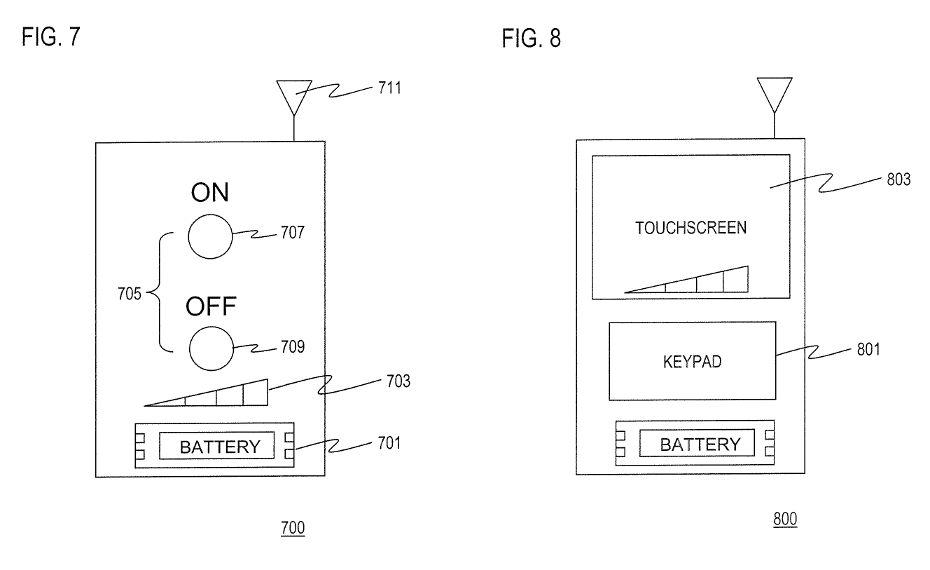

Further, gang boxes 121a-121d may be actuated (i.e., powered on/off) wirelessly via a control device, e.g., mobile control device 123 or stationary control device 125 mounted to wall 103a. That is, wireless coded signals of different carrier frequencies may be provided via transmitter to alter electrical states (e.g., on/off states) of one or more electrical devices. Exemplary control devices are described with respect to FIGS. 7 and 8.

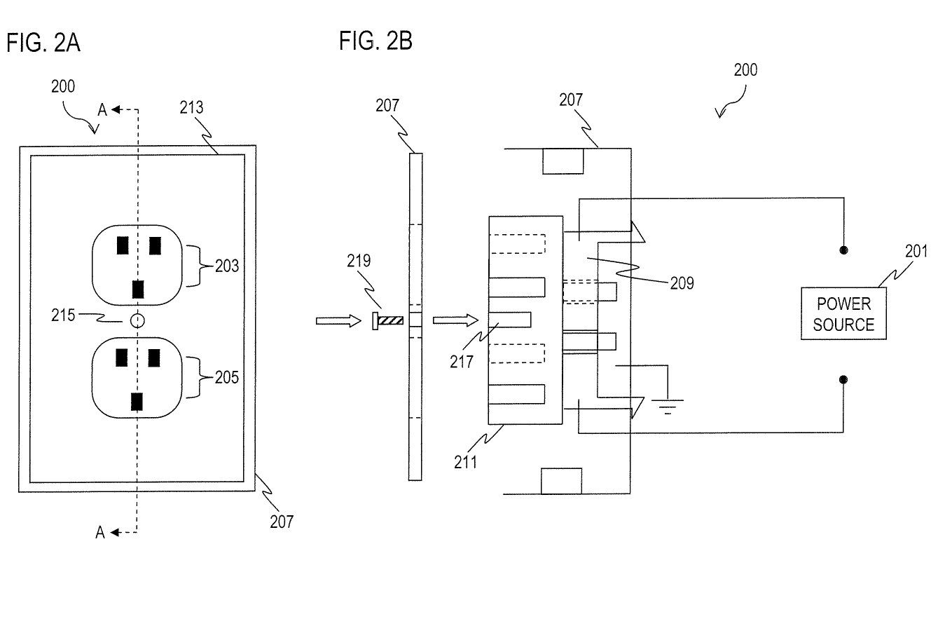

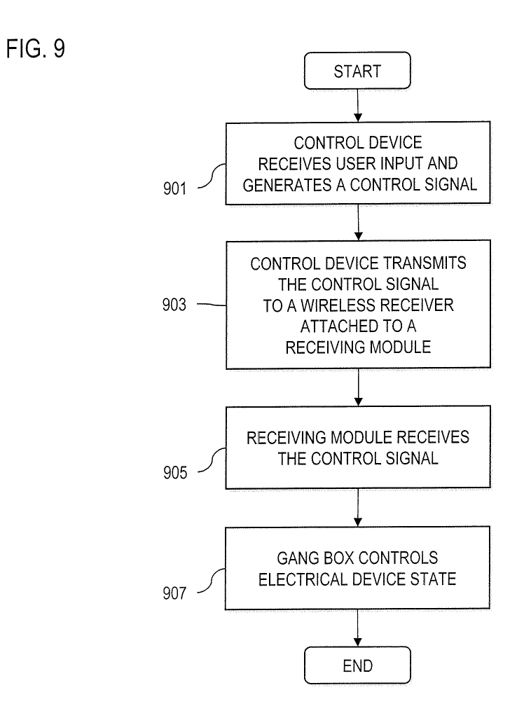

In alternative embodiments, gang boxes (e.g., box 121e) may be mechanically operated to actuate other gang boxes (e.g., box 121b) in a conventional manner and one or more other gang boxes (e.g., box 121a) wirelessly. Accordingly, gang boxes 121a-121e may selectively incorporate wireless receivers controlled by devices 123 and/or 125. An exemplary gang box is described with respect to FIGS. 2A, 2B, 3A, 3B, 4A-4C, and 5A-5C. An overall process for controlling one or more electrical devices is provided according to FIG. 9.

FIGS. 2A and 2B are, respectively, a front view and a cross-sectional view of an electrical gang box, according to an exemplary embodiment. Particularly, FIG. 2B is a cross-sectional view taken along section line A-A of FIG. 2A. In the depicted embodiment, electrical gang box 200 is shown to provide a duplex receptacle, which functions to supply a user with electrical power from a power source 201. That is, gang box 200 includes two electrical sockets, e.g., an upper socket 203 and a lower socket 205, each having three apertures for receiving conventional three-pronged plugs. In this manner, gang box 200 may be installed within or mounted to a wall (e.g., gang box 121d), ceiling (e.g., gang box 121a), or floor assembly, as well as incorporated with support structures (e.g., gang box 121c) within an environment, such as building structure 101. As such, an electrical current may propagate from power supply 201 to an electrical device, such as lamp 115, via gang box 121d.

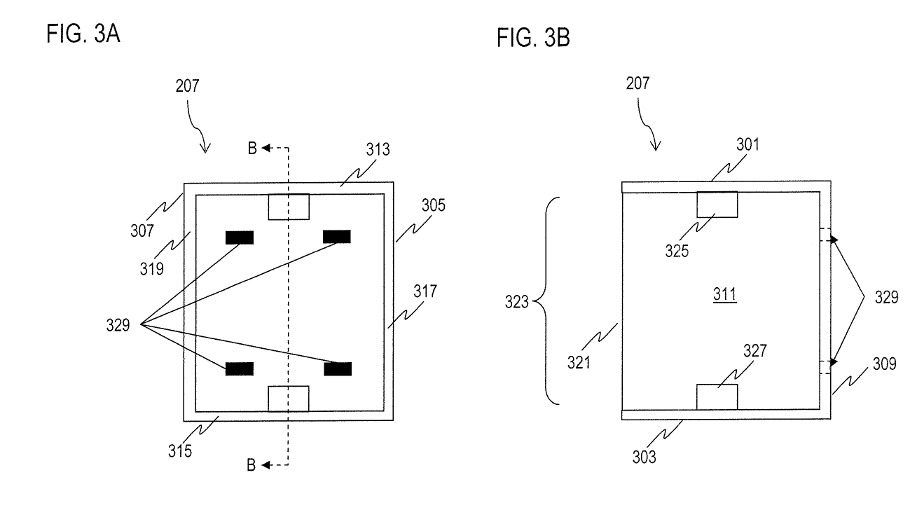

More specifically, gang box 200 comprises an insulating housing 207, a controllable receiving module 209, and an interchangeable receptacle module 211. Receiving module 209 is configured to be installed within housing 207, wired to power supply 201, and receive receptacle module 211. Meanwhile, receptacle module 211 is configured to be detachably “plugged” into receiving module 209 and receive conventional three-pronged plugs. Moreover, a faceplate 213 may be fastened to receptacle module 211 via fastening apertures 215 and 217 and, for example, an attachment screw 219, so as to provide an aesthetic trim. With continued reference to FIGS. 2A and 2B, each of the component parts of gang box 200 will now be more fully described in conjunction with FIGS. 3A, 3B, 4A-4C, and 5A-5C.

FIGS. 3A and 3B are a front view and a cross-sectional view of a housing of the electrical gang box of FIG. 2, according to an exemplary embodiment. Particularly, FIG. 3B is a cross-sectional view taken along section line B-B of FIG. 3A. Housing 207 comprises a shell-like, insulating structure having exterior facades 301, 303, 305, 307, and 309 substantially enclosing an interior chamber 311. As such, facades 301-307 have forward edges 313, 315, 317, and 319, which together form a front peripheral edge 321 of an opening 323 of housing 207. Opening 323 permits access to interior chamber 311. Mounting structures 325 and 327 can be employed to secure housing 207 to aspects of a building structure, e.g., a stud or joist, via attachment screws, for example.

Additionally, a rear facade 309 includes a plurality of slots 329 (or catches) of a latch and catch assembly for detachably coupling receiving module 209 within interior chamber 311, as illustrated in FIG. 2B. In other embodiments, mounting structures can be provided to secure receiving module 209 to housing 207. Further, a matrix of knockouts (not shown) may be provided for attaching conduits or fittings to housing 207. Further, knockouts can provide additional tool access to interior chamber 311 and afford supplemental wire routing capabilities. In this regard, housing 207 may be made of a suitable plastic material (e.g., thermoplastic nylon, polycarbonate, polyvinyl chloride, etc.) and manufactured utilizing conventional molding techniques (e.g., injection molding). Alternatively, housing 207 may be constructed out of a metal (e.g., stainless steel, aluminum, etc.) through sheet-metal fabrication techniques, or by some other manufacturing process (e.g., casting).

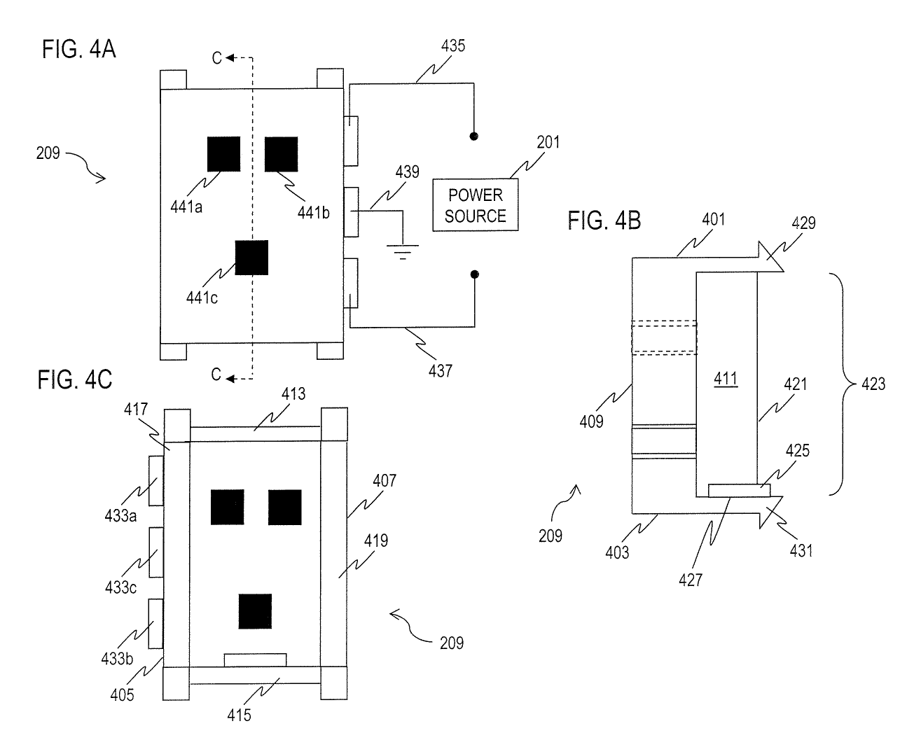

FIGS. 4A-4Cc are a front, a cross-sectional, and a back view of a receiving module of the electrical gang box of FIG. 2, according to an exemplary embodiment. Particularly, FIG. 4B is a cross-sectional view taken along section line C-C of FIG. 4A. Receiving module 209 comprises a shell-like body having exterior facades 401, 403, 405, 407, and 409 substantially enclosing an interior chamber 411. Facades 401-407 have rearward edges 413, 415, 417, and 419, which together form a rear peripheral edge 421 of an opening 423 of receiving module 209. Opening 423 permits access to interior chamber 411. As such, a wireless receiver device 425 may be installed to an interior surface (e.g., surface 427) of interior chamber 411. For instance, wireless receiver 425 may be magnetically coupled, adhesively attached, or otherwise joined to interior surface 427. Instead, wireless receiver 425 may be detachably coupled to housing 207. In either case, wireless receiver 425 can be wired between power source 201 and upper and lower sockets 203 and 205.

Accordingly, wireless receiver 425 can be configured to receive control signals from a wireless control device (e.g., control device 123), wherein wireless connections may be established via infrared (IR) or radio-frequency (RF) signals that may use short-range RF interconnections, such as the BLUETOOTH protocol. It is recognized that BLUETOOTH enables low-cost, low-power radio-based wireless links to be established over relatively short-ranges. For instance, BLUETOOTH can enable communication ranges of approximately 30 feet, on a 2.45 gigahertz band, moving data at about 721 kilobits per second, or faster, i.e., a sufficient carrier medium for controlling most interior spaces.

As such, wireless receiver 425 may be pre-programmed with a code to provide a selected output response signal (e.g., pulse coded signal) in response to a coded signal received from a transmitting device, such as control device 123. In other embodiments, hard-wired circuitry and/or software may be used in conjunction with wireless receiver 425. For instance, wireless receiver 425 may contain a microcontroller to control outputs (i.e., selected pulse-coded signal) to toggle between powered “on” and powered “off” states of an electrical device, e.g., lamp 115. Thus, wireless receiver 425 can enable users to control and configure gang box 200 without mechanical operation or electrical rewiring. For instance, upper and lower sockets 203 and 205 may be individually switched at any given period via control signal instead of requiring a conventional mechanical switch to be wired into the circuit pattern.

Referring back to FIGS. 2B and 4B, receiving module 209 may advantageously “snap” into housing 207 via latches 429 and 431 of the previously mentioned latch and catch assembly. That is, latches 429 and 431 of receiving module 209 may be engaged into the plurality of catches 329 of housing 207 to detachably couple the component parts to one another. In alternative embodiments, receiving module 209 and housing 207 may be integrally formed into a single member of gang box 200, i.e., a combined housing member.

As seen in FIGS. 4A and 4B, a side facade 405 of receiving module 209 includes terminals 433a-433c (e.g., screw terminals) for wiring the device to power supply 201. For instance, a “hot” wire 435 can be connected to terminal 433a, a “neutral” wire 437 can be connected to terminal 433b, and a “ground” wire 439 can be connected to terminal 433c. Hot wire 435 and neutral wire 437 establish an electrical circuit with power supply 201, while ground wire 439 grounds gang box 200. An electrical bus may be established between terminals 433a-433c and a plurality of corresponding female apertures 441a-441c incorporated into front facade 401. Female apertures 441a-441c are configured to receive male posts (or blades) of receptacle module 211. In this regard, aperture 441a creates a “hot” path, aperture 441b creates a “neutral” path, and aperture 441c creates a “ground” path to receptacle module 211. Thus, receiving module 209 and receptacle module 211 may be electrically coupled.

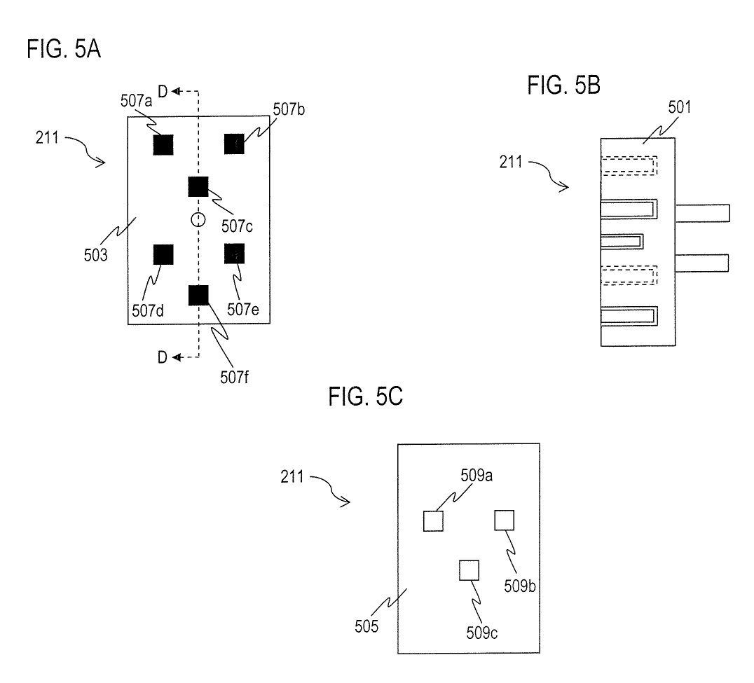

FIGS. 5A-5C are a front, a cross-sectional, and a rear view of a receptacle module of the electrical gang box of FIG. 2, according to an exemplary embodiment. Particularly, FIG. 5B is a cross-sectional view taken along section line D-D of FIG. 5A. In the depicted embodiment, receptacle module 211 comprises a main body 501 including a front facade 503 and a rear facade 505. Front facade 503 incorporates a plurality of female apertures 507a-507f extending into main body 501. Meanwhile, a plurality of male posts 509a-509c (or blades) extend from rear facade 505.

Accordingly, female apertures 507a-507c define upper socket 203, while female apertures 503d-503f define lower socket 205. That is, apertures 507a and 507d are provided as “hot” contacts, apertures 507b and 507e comprise “neutral” contacts, and apertures 507c and 507f are configured as “ground” contacts. As such, upper and lower sockets 203 and 205 are provided in “ground-down” orientations. Other embodiments provide sockets 203 and 205 in “ground-up” or “ground-side” configurations, as well as oriented in combined directional matrices. Further, while only a duplex receptacle is illustrated, it is contemplated that any number of electrical sockets may be included so as to provide a triplex receptacle, a quadplex receptacle, or other like configuration. In any of the above cases, female apertures 507a-507f can be formed to receive a conventional three-pronged plug (not illustrated) of an electrical device, e.g., lamp 115.

Similarly, receptacle module 211 may be “plugged” into receiving module 209 via male posts 509a-509c. That is, male posts 509a-509c of receptacle module 211 may be mechanically inserted into corresponding female apertures 441a-441c. In conjunction with the electrical properties previously described, male posts 509a-509c and female apertures 441a-441c also sever as a mechanical coupling mechanism. As such, receptacle modules 211 may be easily removed (i.e., pulled from) from gang box 200 without disturbing the hard wire configurations of receiving module 209. Furthermore, given the ease of removability, it is contemplated that module 211 may comprise other electrical components, such as switches, dimmers, etc. As such, the functional characteristics of gang boxes (e.g., gang box 200) may be seamlessly interchanged (physically and logically) to provide endless opportunity to vary control conditions affecting power distributions, outlet parameters, a lighting characteristics, or operating states of the previously mentioned electrical devices of FIG. 1.

Before describing exemplary processes for installing and reconfiguring electrical gang box 200, drawbacks of conventional methods are explored. A typical alternating current (AC) electrical system includes at least one electrical box housing an electrical device, such as an outlet or switch. During a preliminary stage, the electrical box may be mounted to a wall stud or a ceiling/floor joist. At a routing stage, un-terminated power cables may be “feed” into the electrical box and folded back until an electrical device is required. After a decision phase, the power cables may be hard wired to an appropriate component, e.g., outlet. In this manner, excess cable slack is bunched behind the electrical device so that the device can be mounted to the electrical box. Decorative faceplates may then be installed over the unit for aesthetic trim.

In order to reconfigure the function of a conventional electrical box (or replace existing components), the existing electrical device must be un-wired in order to hard wire a new device in its place. For a typical occupant of an environment (e.g., homeowner), this process creates shock hazards. Moreover, if an electrical device is incorrectly wired or the power cables get kinked or nicked, building codes may be violated, not to mention creating inadvertent fire or shock risks. With this knowledge, an occupant may be reluctant to hire an expensive electrician to replace worn out or damaged components, thus increasing the aforementioned dangers. Furthermore, these dangers are exacerbated by the bunching and handling of wires in an electrical box, all of which degrade the integrity of the electrical system. The above being noted, it also takes a considerable amount of time to safely accomplish these tasks.

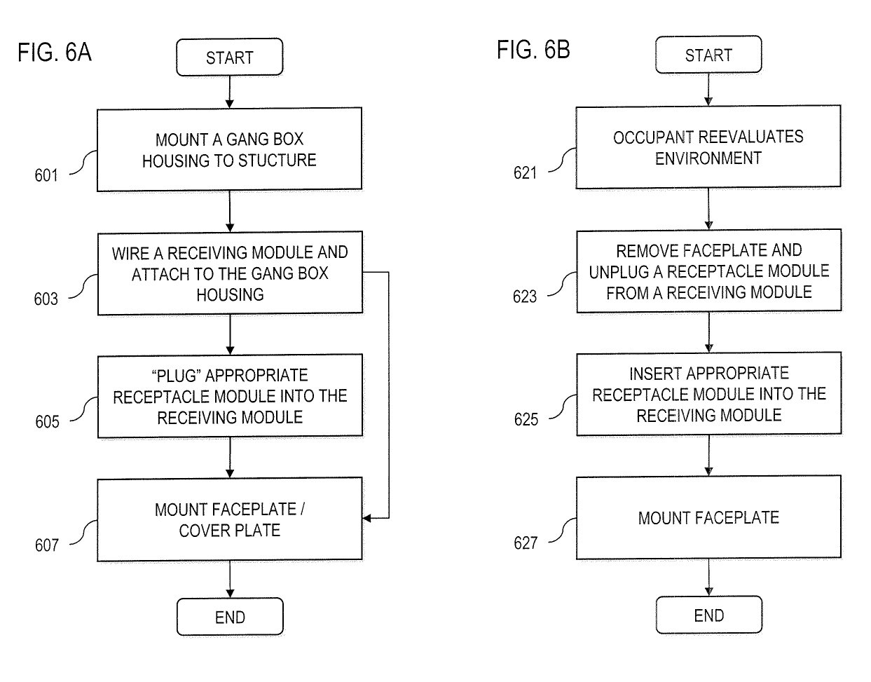

Various embodiments of the invention reduce the above risks by providing modular components that can be seamlessly interchanged and advantageously controlled via wireless control devices from practically any given location, at almost any moment in time. FIGS. 6A and 6B are flowcharts of processes for installing and reconfiguring an electrical gang box, according to various exemplary embodiments. Particularly, FIG. 6A describes an exemplary procedure for installing a single gang box; however, the process may be repeated as required. In step 601, a certified electrician mounts a gang box housing 207 to a building structure via a stud, joint or other mountable surface. This can be accomplished utilizing mounting structures 325 and 327 of housing 207. A number of knockouts may be removed to outfit conduits or other appropriate fittings.

Per step 603, the electrician may route power cables (i.e., hot, neutral, and ground wires) into housing 207 and hard wire receiving module 209 via terminals 433a-433c. In this manner, receiving module 209 may be coupled (or “snapped”) to housing 207 via, for example, the latch and catch assembly. Namely, latches 429 and 431 of receiving module 209 may be engaged into the plurality of catches 329 of housing 207 to detachably couple the component parts to one another. During this process, excess wiring may be routed from housing 207 to provide a “clean” housing free from bunched wires.

At this point, the process may toggle to step 605 or advance to step 607. That is, since receiving module 209 safely terminates the power cables, the chance of a short circuit, fire hazard, or electrical shock is greatly reduced. Therefore, an electrician may mount a cover plate over housing 207 until gang box 200 is required, as per step 607. Alternatively, in step 605, an appropriate receptacle module 211 may be “plugged” into receiving module 209. That is, the male posts 509a-509c of receptacle module 211 may be engaged into the female apertures 507a-507c of receiving module 209, thereby mechanically and electrically coupling the component parts. The process may then proceed to step 607, wherein a faceplate 213 is mounted to receptacle module 211 via fastening apertures 215 and 217 via, for example, an attachment screw 219. As a safety precaution, the control device may set the initial state of receiving module 209 to an “off,” i.e., deenergized, state. An exemplary control procedure is provided with respect to FIG. 9.

FIG. 6B provides an exemplary procedure for mechanically reconfiguring gang box 200. In step 621, an occupant may reevaluate their environmental use, needs, or whimsical desires. As such, the occupant may determine that electrical gang box 200 requires adjustment, i.e., a replacement or differently functioning receptacle module 211 must be installed. Accordingly, the occupant can then seamlessly effectuate the reconfiguration process since no wiring procedure is required. At step 623, receiving module 209 may be set to an “off” state to prevent any chance of electrical shock. Attachment screw 219 may be unscrewed, thereby permitting faceplate 213 to be removed. With the existing receptacle module exposed, the occupant may simply unplug the component from receiving module 209, much like unplugging a power cord from a conventional outlet socket. Per step 625, a new receptacle module 211 may be effortlessly plugged into the vacant space. At step 627, faceplate 213 may be remounted and receiving module toggled to an “on,” or energized state.

FIGS. 7 and 8 are diagrams of transmitters configured to permit users to manage the configurable state of an electrical gang box, according to exemplary embodiments.

Referring to FIG. 7, a control device 700 is illustrated for remotely managing functions of one or more electrical gang boxes (e.g., box 200). As such, parameters of various electrical devices, such as lamp 115, may be controlled based on transmitted signals from control device 700. With particular reference to controlling a lighting apparatus, control device 700 may permit users to modify at least one control parameter, such as illuminating intensity, applied voltage/current/power, effective resistance/inductance/capacitance, and/or an on/off state, as well as other like characteristics. Control device 700 may also be utilized to control other electrical devices, i.e., those mentioned with respect to FIG. 1.

According to various embodiments, power is supplied to control device 700 via one or more batteries, e.g., battery 701. A power indicator 703 is provided for assessing remaining battery life. Control device 700 also includes a user interface 705 in communication with a control logic (not depicted) for transmitting control signals to receiving modules, via wireless receivers (e.g., wireless receiver 425). In this regard, user interface 705 receives user input (e.g., via mechanical or logical actuation) to generate user output (e.g., a control signal). In one embodiment, user interface 705 includes buttons 707 and 709 for turning on/off, as well as, adjusting the illuminating intensity of a light, e.g., lamp 115. As seen in FIG. 8, the user interface may be implemented as a keypad 801 or a touchscreen 803. In still further embodiments, user input may be received at control device 800 via voice recognition systems.

Control device 700 transmits control signals to receivers 425 utilizing a wireless connection established, for instance, via infrared (IR) or radio-frequency (RF) signals. In one particular embodiment, control device 700 utilizes a short-range RF interconnection, such as provided by the BLUETOOTH protocol. Further, control device 700 may include a transmitter comprising a variable oscillator, a modulator, a variable gain amplifier, and transmitting antenna 711 to facilitate signal transmission. Accordingly, control logic may generate an output signal in response to user input. The output signal may be transformed into sequential carrier signals of a carrier frequency by the variable oscillator. In response to this data, the carrier signals may be modulated via the modulator. A variable gain amplifier may be provided to amplify the modulated carrier to produce an appropriate control signal for transmission via antenna 711.

In other embodiments, control device 700 includes non-volatile memory, such as a flash memory, that can be read from or written to by the control logic. The flash memory may hold information used by the control logic for generating a sequence of control signals. Additionally, the flash memory may store data for associating particular control signals with particular electronic devices. As such, control logic may be implemented via a microcontroller executing code stored in the non-volatile memory. Alternatively, control logic may be implemented via a combination of analog and digital discreet components. In particular embodiments, the components of control device 700 may be implemented on a single integrated circuit, thereby decreasing manufacturing costs.

FIG. 9 is a flowchart of a process for controlling an electrical device via control device, according to an exemplary embodiment. In step 901, control device receivers user input, such as the actuation of “on” or “off” buttons 707 and 709. Control logic may convert the event to an output signal. For instance, depressing button 707 once may cause control logic to create a “power on” signal, while depressing button 709 once may cause control logic to create a “power off” signal. Furthermore, holding either button 707 or 709 down may create a corresponding dimming effect.

As such, control device 700 transmits the output signal as a control signal to one or more wireless receivers, e.g., wireless receiver 425, per step 903. At step 905, a receiving module 211 receives the control signal via wireless receiver 425. Accordingly, control signal effectuates a change in one or more circuit parameters of gang box 200. At step 907, the modified circuit parameter adjusts a state (e.g., powered on, powered oft) of an electrical device, e.g., lamp 115.

In the proceeding description, the present invention is described with reference to specifically exemplary embodiments thereof. It will, however, be evident that various modifications and changes may be made thereto without departing from the broader spirit and scope of the present invention, as set forth in the claims. The specification and drawings are, accordingly, to be regarded as illustrative and not as restrictive. It is understood that the present invention is capable of using various other combinations and embodiments and is capable of any changes or modifications within the scope of the inventive concept as expressed herein.

What is claimed is:

1. An apparatus comprising:
a receptacle having a plurality of female slots and a plurality of male ends, wherein the female slots are configured to receive a plug of a lighting system; and
a receiving module, wired to a power supply, having a plurality of female slots configured to receive male ends of the receptacle, wherein the female slots of the receiving module and the male ends of the receptacle are detachably connected to electrically couple to the lighting system.

2. An apparatus according to claim 1, wherein the connection among the female slots of the receiving module and the male ends of the receptacle is made without wires.

3. An apparatus according to claim 1, wherein the receiving module can be detachably attached into a housing adapted to be mounted into a fixture disposed within a wall or a ceiling.

4. An apparatus according to claim 3, wherein the receiving module is attached within the housing using a magnetic back or self-adhesive strip.

5. An apparatus according to claim 1, wherein the receiving module is wired to a power supply.

6. An apparatus according to claim 1, further comprising:
a wireless receiver being installed within the receiving module and configured to receive a coded signal, wherein a microcontroller is configured to control a power level based on the received coded signal; and
a transmitter configured to transmit the coded signal to the wireless receiver to control the lighting levels of the lighting system.

7. An apparatus according to claim 6, wherein the wireless transmitter includes a memory for storing lighting level settings.

8. A method for installing wireless control system for controlling a lighting system, comprising:
detachably engaging a receptacle to a receiving module, wherein male ends of the receptacle are engaged into female slots of the receiving module, wherein the receptacle has a plurality of female slots for receiving a plug of the lighting system; and
placing a wireless receiver within the receiving module and the receiving module is detachably installed within a housing disposed within a wall or a ceiling.

9. A method according to claim 8, wherein the connection among the female slots of the receiving module and the male ends of the receptacle is made without wires.

10. An method according to claim 8, wherein the receiving module is attached within the housing using a magnetic back or self-adhesive strip.

11. An method according to claim 8, wherein the receiving module is wired to a power supply.

12. A method according to claim 8 further comprising:
placing a wireless receiving module within the receiving module for receiving a coded signal, wherein a microcontroller is configured to control a power level based on the received coded signal and
arranging a wireless transmitter configured to transmit the coded signal to the wireless receiver to control the lighting levels of the lighting system.

13. An method according to claim 12, wherein the wireless transmitter includes a memory for storing lighting level settings.

14. A gang box comprising:
a housing;
a receiving module including a wireless receiver; and
a receptacle module,
wherein the housing is configured to support the receiving module, the receptacle module is configured to be detachably coupled to the receiving module, and the receiving module is configured to be hard wired to a power source,
wherein an electrical state of the receptacle module may be controlled via control signals received at the wireless receiver.

15. A gang box according to claim 14, wherein the wireless receiver is configured to control a lighting system.

16. A gang box according to claim 14, wherein the wireless receiver is configured to control an electrical appliance.

17. A gang box according to claim 14, wherein the receiving module and the receptacle is electrically coupled using blades.
